(19) United States
(12) Patent Application Publication
(10) Pub. No.: US 2012/0127278 A1
(43) Pub. Date: May 24, 2012

(54) 3 DIMENSIONAL CAMCORDER

(75) Inventor: Hsin-Chih Liu, Guishan Township (TW)

(73) Assignee: DXG Technology Corp., Taipei (TW)

(21) Appl. No.: 13/299,517

(22) Filed: Nov. 18, 2011

(30) Foreign Application Priority Data
Nov. 19, 2010 (TW) 099222574

(51) Int. Cl. H04N 13/02

(52) U.S. Cl. 348/49; 348/E13.074

(57) ABSTRACT

A 3D camcorder includes a lens carrier with a first and second lenses and a body component is provided. The lens carrier is rotatable in between a first state and a second state. In the 3D camcorder, the lenses are laid vertically when the lens carrier is at the first state, and the lenses are laid horizontally when the lens carrier is at the second state. The body component is connected to the lens carrier and includes an image processing circuit, for processing continuous pictures captured by the first and second lenses and generating continuous 3D images when the body component is at the second state.

This application claims the benefit of Taiwan application Serial No. 99222574, filed Nov. 19, 2010, the subject matter of which is incorporated herein by reference.

### FIELD OF THE INVENTION

The present invention relates to a 3 dimensional (3D) camcorder, and more particularly to a 3D camcorder with a rotatable lens carrier.

### BACKGROUND OF THE INVENTION

Traditionally, camera and camcorder capture and display images in 2 dimensions. Nowadays, 3D camera and camcorder are capable of displaying images in 3D and images displayed are more vivid. Hence 3D devices become very popular recently.

FIG. 1 is a schematic view of a conventional 3D camera. The main body of the 3D camera 100 includes: a snapshot button 110, a flashlight 120, and two lenses 130, 135. With proper use of the flashlight 120, the two lenses 130, 135 are capable of capturing images of an object simultaneously from two respective positions when the snapshot button 110 is pressed.

According to FIG. 1, the two lenses 130, 135 are laid horizontally to simulate the image seen by naked eyes. The images captured by the two lenses 130, 135 are displayed in 3D mode after processed by an internal 3D image processing circuit. Generally speaking, horizontal interval between the two lenses 130, 135 and eyes of human being is approximately 6 to 10 centimeters for providing good 3D quality. It is known that the 3D effects are better if the horizontal interval between the two lenses 130, 135 is greater.

The operation of a 3D camcorder is similar to the 3D camera. FIG. 2 is a schematic view of a conventional 3D camcorder. The 3D camcorder 200 includes a lens carrier 210, a main body 220, and a display component 230. Since the function and operation details of the main body component 220, and the display component 230 are analogous to a 2D camcorder, further explanations are avoided for the sake of redundancy.

Different from the 2D camcorder, the lens carrier 210 of the 3D camcorder 200 is equipped with two horizontally laid lenses 215, 218. Therefore, the continuous 3D images captured by the two lenses 215, 218 are restored and displayed after processed by the 3D image processing circuit (not shown) in the main body 220 of the 3D camcorder 200. The restored 3D images are displayed by the display component 230 in the 3D camcorder 200.

It is known that the 3D camcorder 200 is deigned to be held by a single hand. However, the horizontal interval between the two lenses 215, 218 on the lens carrier structure 210 is required to be greater than a minimum interval. This results in that the shell of the lens carrier 210 is consequently big. Under such circumstance, the 3D recorder 200 is not compact and its size is not easy for storage.

### SUMMARY OF THE INVENTION

Therefore, the present invention provides a 3D camcorder with a rotatable lens carrier. The size of the 3D camcorder is compact and easy for storage.

An embodiment of the present invention provides a a lens carrier with a first lens and a second lens, wherein the lens carrier is rotatable in between a first state and a second state, the lenses are laid vertically when the lens carrier is at the first state, and the lenses are laid horizontally when the lens carrier is at the second state; and a body component, connected to the lens carrier, comprising an image processing circuit, for transforming continuous pictures captured by the first and second lens to continuous 3D images when the body component is at the second state.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior Art) is a schematic view of a conventional 3D camera;

FIG. 2 (Prior Art) is a schematic view of a conventional 3D camcorder;

FIG. 3 is a schematic view of a 3D camcorder at a first state according to an embodiment of the present invention; and

FIG. 4 is a schematic view of the 3D camcorder at a second state according to an embodiment of the present invention.

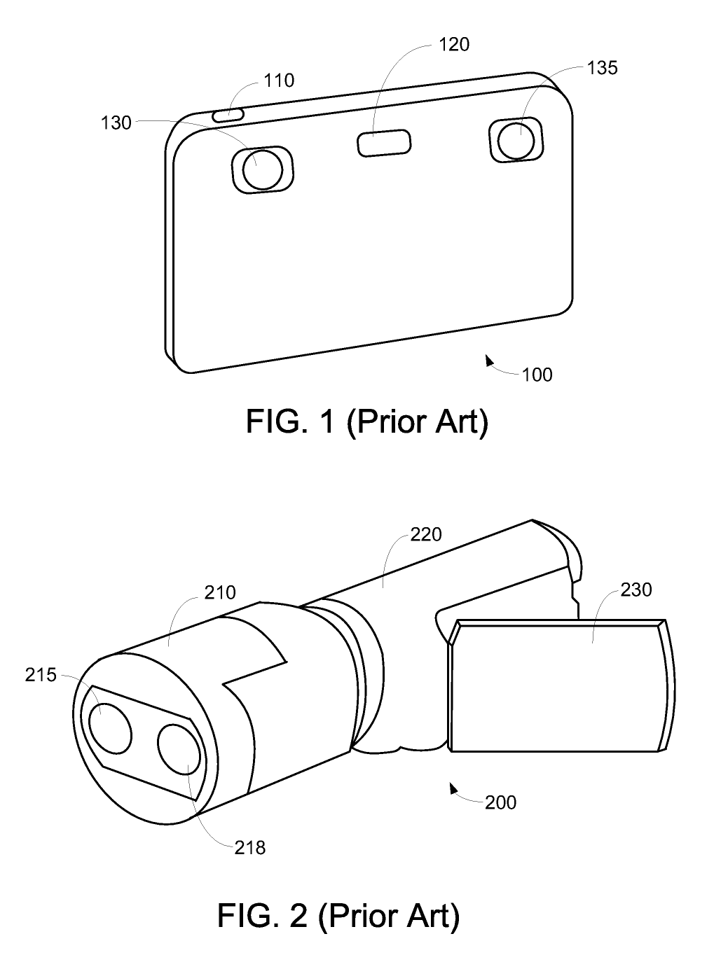

### DETAILED DESCRIPTION OF PREFERRED EMBODIMENTS

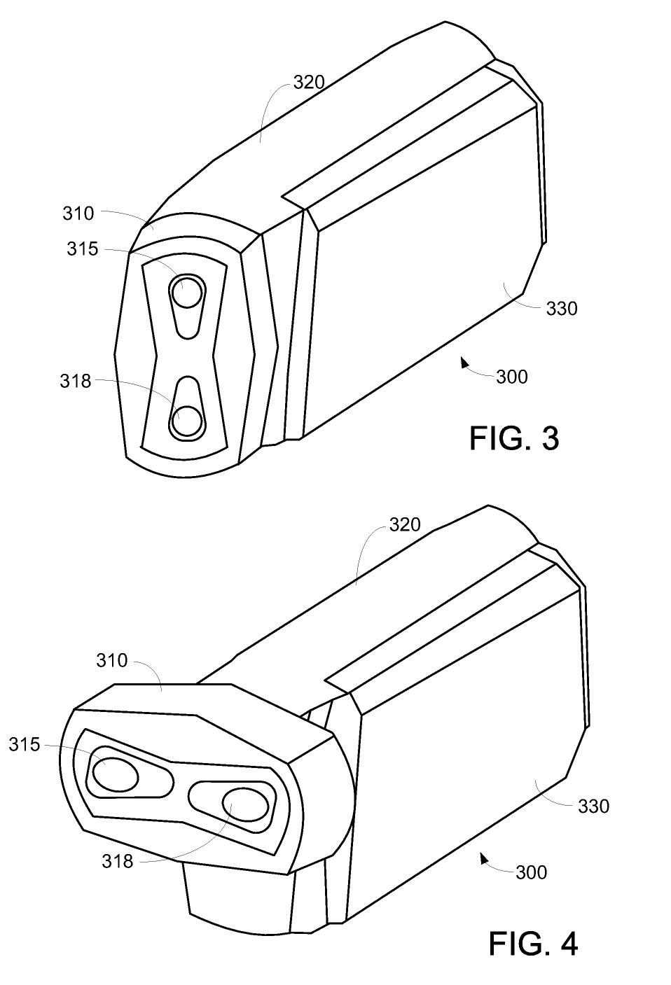

FIG. 3 is a schematic view of a 3D camcorder at a first state according to an embodiment of the present invention. The 3D camcorder 300 includes a lens carrier 310, a body component 320, and a display component. Since the function and the operation of the body component 320, and the display component 330 are similar to the conventional camcorders, details of such are not further described.

According to an embodiment of the present invention, the 3D camcorder 300 is with a rotatable lens carrier 310 exhibiting two lenses 315, 318. The lens carrier 310 is capable of being rotated in between a first and second states. At the first state, the two lenses 315, 318 are laid vertically. The 3D camcorder is either switched off or only one of the lenses 315, 318 is turned on for recording. For instance, only the lens 315 is used to capture continuous images when the 3D camcorder is at the first state. At meanwhile, the image processing circuit (not shown) in the body component of the 3D camcorder does not precede 3D image processing. In another application, the 3D camcorder 300 is turned off at the first state for storage consideration.

FIG. 4 is a schematic view of the 3D camcorder at a second state according to an embodiment of the present invention. According to the embodiment of the present invention, when the 3D camcorder 300 is at the second state, the two lenses 315, 318 are laid horizontally. At the meanwhile, images captured by the two lenses 315, 318 are continuously processed by the image processing circuit (not shown) of the body component 320. Hence the 3D images after processed are displayed by the display component 330. When the 3D camcorder 300 is at the second state, it is also possible to use only one lens (for instance, the lens 315) to capture images.

Since the lens carrier 310 is rotatable, the interval between the two lenses 315, 318 is constant. At the first state, the two lenses 315, 318 are laid vertically so that the shell of the lens carrier 310 is not too wide. Therefore, the shell of the lens carrier 310 is relatively small and easily to store.

Moreover, when the lens carrier 310 is rotated to the second state, the two lenses 315, 318 are laid horizontally. At the second state, the 3D camcorder 300 is operated by a user to continuously capture and process 3D images.

An advantage of the present invention is to provide a 3D camcorder with the rotatable lens carrier. The states of the lens carrier may be changed according to needs of a user. The two lenses in the lens carrier are laid horizontally for recording 3D images or vertically for capturing non-3D images or storage.

It should be noted that the rotatable lens carrier can be applied to different 3D devices. For instance, a 3D camcorder without the display component, such as a 3D web camera, can be a variant application of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A 3 dimensional camcorder comprising:
a lens carrier with a first lens and a second lens, wherein the lens carrier is rotatable in between a first state and a second state, the lenses are laid vertically when the lens carrier is at the first state, and the lenses are laid horizontally when the lens carrier is at the second state; and
a body component, connected to the lens carrier, comprising an image processing circuit, for processing continuous images captured by the first and second lenses and generating continuous 3D images when the body component is at the second state.

2. The 3 dimensional camcorder as claimed in claim 1, further comprising a display component connected to the body component for displaying the continuous 3D images.

3. The 3 dimensional camcorder as claimed in claim 1, wherein the 3D camcorder is turned off or only the first lens is utilized to capture the continuous images when the lens carrier is at the first state.
